(19) United States
(12) Patent Application Publication
(10) Pub. No.: US 2013/0078588 A1
(43) Pub. Date: Mar. 28, 2013

(54) METHOD FOR HEAT-TREATING SILICON WAFER

(71) Applicants: Takeshi Senda, Kitakanbara-gun (JP); Koji Araki, Kitakanbara-gun (JP); Tatsuhiko Aoki, Kitakanbara-gun (JP); Haruo Sudo, Kitakanbara-gun (JP); Susumu Maeda, Hadano-shi (JP)

(72) Inventors: Takeshi Senda, Kitakanbara-gun (JP); Koji Araki, Kitakanbara-gun (JP); Tatsuhiko Aoki, Kitakanbara-gun (JP); Haruo Sudo, Kitakanbara-gun (JP); Susumu Maeda, Hadano-shi (JP)

(73) Assignee: Covalent Silicon Corporation, Kitakanbara-gun (JP)

(21) Appl. No.: 13/626,151

(22) Filed: Sep. 25, 2012

(30) Foreign Application Priority Data
Sep. 27, 2011 (JP) 2011-210809
Sep. 6, 2012 (JP) 2012-196014

(51) Int. Cl. F27D 3/00

(52) U.S. Cl. 432/9

(57) ABSTRACT

A method for heat-treating a silicon wafer is provided in which in-plane uniformity in BMD density along a diameter of a bulk of the wafer grown by the CZ process can be improved. Further, a method for heat-treating a silicon wafer is provided in which in-plane uniformity in BMD size can also be improved and COP of a surface layer of the wafer can be reduced. The method includes a step of a first heat treatment in which the CZ silicon wafer is heated to a temperature from 1325 to 1400° C. in an oxidizing gas atmosphere, held at the temperature, and then cooled at a cooling rate of from 50 to 250° C./second, and a step of a second heat treatment in which the wafer is heated to a temperature from 900 to 1200° C. in a non-oxidizing gas atmosphere, held at the temperature, and then cooled.

### BACKGROUND OF THE INVENTION

1. Field of the Invention

The present invention relates to a method for heat-treating a silicon wafer (hereinafter simply referred to as wafer) sliced from a silicon single crystal ingot grown by Czochralski process (hereinafter referred to as the CZ process).

2. Description of the Related Art

Recent highly-integrated semiconductor devices require a severer quality of a silicon wafer used as a substrate for such semiconductor devices. In addition to reduction in density of defects such as COP in a surface layer (for example, depth region from the surface to a depth of 7 μm) which serves as a semiconductor device formation region, there is a need for improvement in wafer resistance to heat treatment where stress is high.

As a method for reducing COP, Japanese Patent Application Publication (KOKAI) No. H6-295912 discloses a technology in which a silicon wafer is subjected to a heat treatment at a heat-treatment temperature of 1100 to 1300° C., for a heat treatment period of 1 minute to 48 hours, in a hydrogen gas atmosphere or a mixed gas atmosphere of hydrogen gas and inert gas, to thereby form a DZ (denuded zone) layer in the surface layer of the silicon wafer.

Further, it is said that an oxide precipitate (Balk Micro Defect; hereinafter referred to as BMD) precipitating at a bulk of the wafer at the time of the above-mentioned heat treatment serves as a gettering site of the impurities to be diffused in the surface layer in a later semiconductor-device forming process and increases wafer strength as well.

Furthermore, it is preferable that a BMD density in the above-mentioned bulk is uniform in plane along a diameter of the wafer. If there are variations in BMD density within the wafer, the wafer strength changes in a portion having the variations. Thus, there is a problem that a slip dislocation may take place originating from this portion in a later semiconductor-device forming heat treatment etc.

It should be noted that the in-plane distribution of the BMD density along a diameter of such a wafer reflects the in-plane distribution of a grown-in defect introduced at the time of growing the single crystal by the CZ process as it is. Therefore, in order to improve the in-plane uniformity in BMD density, it is necessary to uniformly control the in-plane distribution of the grown-in defect introduced at the time of growing the single crystal.

However, there is a problem that such control needs to finely control a crystal heat history of a hot zone etc., a growth rate, etc., leading to very high costs.

Further, in the case where an OSF region including many oxidation induced stacking faults (Oxidation-induced Stacking Fault: hereinafter referred to as OSF) is formed at the time of growing the single crystal, an OSF ring will be generated along a diameter of (or concentrically with) the sliced wafer. In this case, it is known that near the OSF ring in the wafer, there are very few BMD cores introduced at the time of growing the single crystal, i.e., after heat treatment there is a BMD low density region where the BMD density is considerably reduced.

In addition, as a method of not generating such an OSF ring in a wafer surface, Japanese Patent Application Publication (KOKAI) No. H8-330316 discloses a technology in which a crystal growth rate is reduced at the time of growing the single crystal, and concentrations of vacancy and interstitial silicon are balanced, to thereby grow a non-defective area where there are substantially no shortage or excess of an atom.

However, in the method described in Japanese Patent Application Publication (KOKAI) No. H8-330316, there is a problem that the crystal growth rate is decreased to reduce the productivity and lead to high costs, and BMD hardly precipitates in the bulk to reduce the strength of the wafer.

As a means which can improve the in-plane uniformity in the BMD density of the wafer even when the OSF region is formed at the time of growing the single crystal, Japanese Patent Application Publication (KOKAI) No. 2006-93645 discloses a method in which when a wafer containing the OSF ring grown at a nitrogen concentration of from 2.9×10¹⁴ to 5.0×10¹⁵ atoms/cm³ and at an oxygen concentration of from 1.27×10¹⁸ to 3.0×10¹⁸ atoms/cm³ is placed in a heat-treating furnace where a furnace temperature is held at 600 to 800° C. under a reducing gas or inert gas atmosphere and then subjected to the heat treatment at 1000 to 1200° C., a heating rate of 0.5 to 2.0° C./min is maintained until it reaches the heat treatment temperature.

However, the method described in Japanese Patent Application Publication (KOKAI) No. 2006-93645 can increase the BMD density in the BMD low density region, so that the in-plane non-uniformity in the BMD density because of the presence of the OSF ring is improved to some extent. But, the influence at the time of growing the single crystal still remains.

Further, even in the case where the crystal growth rate is increased while controlling the crystal heat history of the hot zone etc. precisely to increase the growth rate and move the above-mentioned OSF ring outwardly, and a V-rich region where a lot of COP's are taken in is formed uniformly along a diameter direction of the wafer, there is a limit to convection control (controlling a number of revolutions of a quartz crucible, furnace pressure, heater temperature, etc.) of a melt at the time of growing the single crystal, thus leading to a further limit to controlling the BMD density in the diameter direction of the wafer uniformly.

### SUMMARY OF THE INVENTION

The present invention arises in view of the above-mentioned situation, and aims at providing a method for heat-treating a silicon wafer which can improve in-plane uniformity in BMD density along a diameter of a bulk of the wafer grown by the CZ process. Further, the present invention aims at providing a method for heat-treating a silicon wafer which can also improve the in-plane uniformity in BMD size and can reduce COP at a surface layer of the wafer.

The method for heat-treating the silicon wafer in accordance with the present invention is characterized by including a step of performing a first heat treatment in which a silicon wafer sliced from a silicon single crystal ingot grown by the CZ process is heated to a first maximum target temperature within a range of from 1325 to 1400° C. in an oxidizing gas atmosphere, held at the above-mentioned first maximum target temperature, and then cooled at a cooling rate of from 50 to 250° C./second, and a step of performing a second heat treatment in which the above-mentioned silicon wafer subjected to the first heat treatment is heated to a second maximum target temperature within a range of from 900 to 1250° C. in a non-oxidizing gas atmosphere, held at the above-mentioned second maximum target temperature, and then cooled.

It is preferable that the cooling rate in the above-mentioned first heat treatment is from 120 to 250° C./second.

It is preferable that the heating rate at which the temperature is raised to the above-mentioned second maximum target temperature in the above-mentioned second heat treatment is from 1 to 20° C./minute.

According to the present invention, the method for heat-treating the silicon wafer which can improve the in-plane uniformity in the BMD density along a diameter of the bulk of the wafer grown by the CZ process is provided. Further, the method for heat-treating the silicon wafer which can also improve the in-plane uniformity in BMD size and can reduce COP at the surface layer of the wafer is provided.

### BRIEF DESCRIPTION OF THE DRAWINGS

FIGS. 1A to 1C are schematic flow diagrams (first heat treatment) in a wafer cross-section for explaining effects of the present invention.

FIGS. 2A to 2C are schematic flow diagrams (second heat treatment) in the wafer cross-section for explaining the effects of the present invention.

FIGS. 3A to 3C are schematic flow diagrams in the wafer cross-section for explaining the effects of the present invention in the first heat treatment in the case where an OSF ring exists along a diameter of a wafer (or concentrically with the wafer).

FIGS. 4A to 4C are schematic flow diagrams (first heat treatment) in the wafer cross-section for explaining the effects of the present invention in the case where an oxygen concentration in the wafer to be heat-treated is high.

FIGS. 5A to 5C are schematic flow diagrams (second heat treatment) in the wafer cross-section for explaining the effects of the present invention in the case where the oxygen concentration in the wafer to be heat-treated is high.

FIG. 6 is a schematic cross-sectional view showing an example of an RTP apparatus used for a method for heat-treating a silicon wafer in accordance with the present invention.

FIG. 7 is a graph showing an example of a temperature sequence of the first heat treatment by RTP.

FIG. 8 is a graph showing an example of a temperature sequence of the second heat treatment using a vertical heat treatment apparatus.

FIG. 9 is a flow chart showing a first embodiment of a method for manufacturing a silicon wafer including the method for heat-treating the silicon wafer in accordance with the present invention.

FIG. 10 is a flow chart showing a second embodiment of the method for manufacturing the silicon wafer including the method for heat-treating the silicon wafer in accordance with the present invention.

FIG. 11 is a flow chart showing a third embodiment of the method for manufacturing the silicon wafer including the method for heat-treating the silicon wafer in accordance with the present invention.

FIG. 12 is a flow chart showing a fourth embodiment of the method for manufacturing the silicon wafer including the method for heat-treating the silicon wafer in accordance with the present invention.

FIG. 13 is a flow chart showing a fifth embodiment of the method for manufacturing the silicon wafer including the method for heat-treating the silicon wafer in accordance with the present invention.

FIG. 14 is a graph showing in-plane distribution of BMD densities along a wafer diameter from the center to the periphery of the wafer in Examples 1 to 3.

FIG. 15 is a graph showing in-plane distribution of the BMD densities along the wafer diameter from the center to the periphery of the wafer in Examples 4 to 6.

FIG. 16 is a graph showing in-plane distribution of the BMD densities along the wafer diameter from the center to the periphery of the wafer in Examples 7 to 9.

FIG. 17 is a graph showing in-plane distribution of the BMD densities along the wafer diameter from the center to the periphery of the wafer in Comparative Examples 1 to 3 and Conventional Example 1.

### DESCRIPTION OF THE PREFERRED EMBODIMENTS

Hereinafter, a preferred embodiment of the present invention will be described in detail with reference to the drawings etc.

A method for heat-treating a silicon wafer in accordance with the present invention includes a step of performing a first heat treatment in which a silicon wafer sliced from a silicon single crystal ingot grown by the CZ process is heated to a first maximum target temperature within a range of from 1325 to 1400° C. in an oxidizing gas atmosphere, held at the above-mentioned first maximum target temperature, and then cooled at a cooling rate of from 50 to 250° C./second, and a step of performing a second heat treatment in which the above-mentioned silicon wafer subjected to the first heat treatment is heated to a second maximum target temperature within a range of from 900 to 1250° C. in a non-oxidizing gas atmosphere, held at the above-mentioned second maximum target temperature, and then cooled.

The present invention is provided with such steps, and therefore can improve in-plane uniformity in BMD density along a diameter of a bulk of the wafer grown by the CZ process. Further, the in-plane uniformity in BMD size can also be improved and COP at a surface layer of the wafer can be reduced.

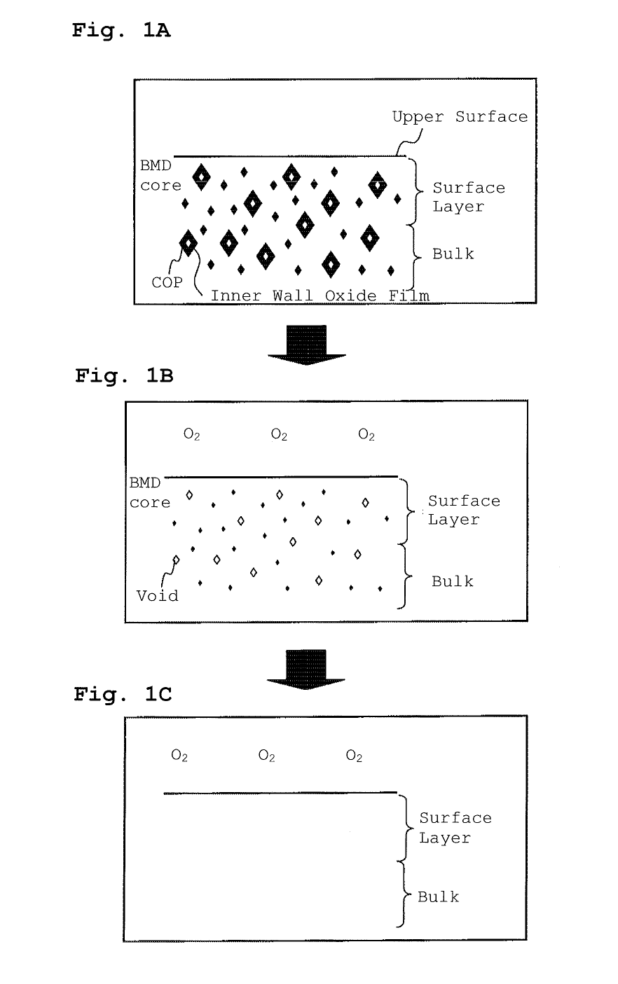

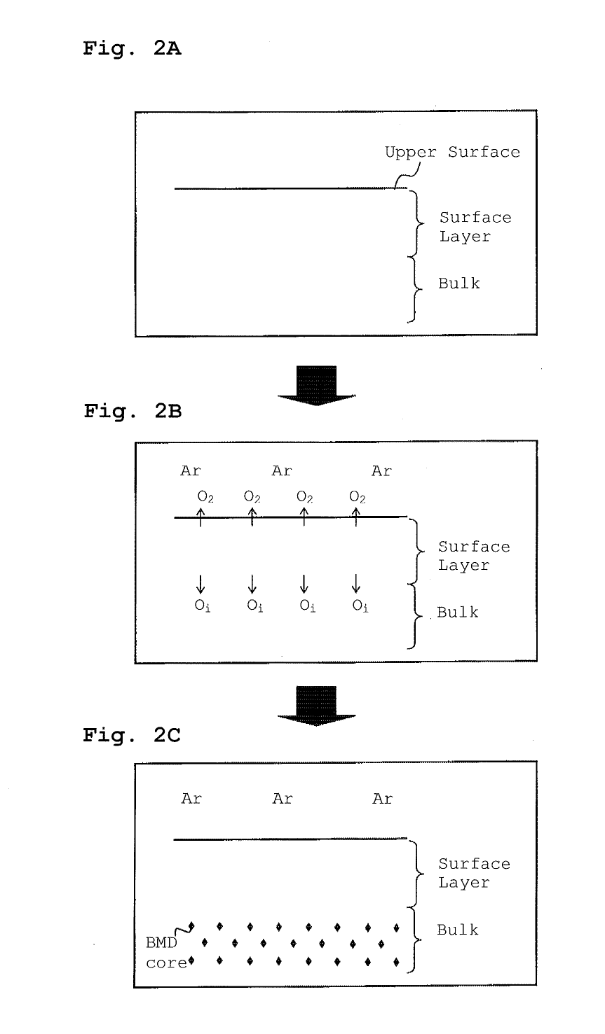

FIGS. 1A to 1C and 2A to 2C are schematic flow diagrams in the wafer cross-section for explaining the effects of the present invention, FIGS. 1A to 1C show the effect caused by the first heat treatment, and FIGS. 2A to 2C show the effect caused by the second heat treatment.

In the first heat treatment, in an oxidizing gas atmosphere (oxygen (O₂) in FIG. 1), since the maximum target temperature is raised to within a range of from 1325 to 1400° C. (first maximum target temperature) and held thereat, an inner wall oxide film (SiO₂) dissolves and results in a void in COP (FIG. 1B). Furthermore, this void diffuses as vacancy to disappear. Or/and, this void disappears since it is filled with a lot of interstitial silicon (not shown) introduced into the wafer due to the oxidizing gas atmosphere (FIG. 1C). Further, since the BMD core introduced at the time of growing the single crystal is heat-treated within the range of the above-mentioned maximum target temperature, it dissolves in the wafer and disappears (FIGS. 1B-1C).

In the second heat treatment, since the maximum target temperature is raised to within the range of from 900 to 1250° C. and held thereat in the non-oxidizing gas atmosphere (argon (Ar) in FIG. 2), oxygen at the surface layer of the wafer is diffused outwards from the wafer surface, and also diffused outwards to the bulk (FIG. 2B). Therefore, a BMD core does not precipitate in the surface layer of the wafer, but precipitates in the bulk (FIG. 2C).

As described above, the BMD core introduced at the time of growing the single crystal dissolves and disappears in the wafer in the first heat treatment, and a BMD core newly precipitates in the bulk in the second heat treatment. Therefore, in the second heat treatment, in a situation where the variations in the BMD core introduced at the time of growing the single crystal are eliminated (canceled once), a BMD core can newly be precipitated and also grown up. Thus, in addition to the in-plane uniformity in the BMD density along the diameter of the wafer, the in-plane uniformity in END size can also be improved.

It is preferable that the maximum target temperature in the first heat treatment (first maximum target temperature) is within the range of from 1325 to 1400° C.

In the case where the above-mentioned first maximum target temperature is low (lower than 1325° C.), it is difficult to dissolve and eliminate the BMD core introduced at the time of growing the single crystal. Therefore, it is difficult to eliminate the variation in the BMD core introduced at the time of growing the single crystal, and it difficult to improve the in-plane uniformity in BMD size in addition to the in-plane uniformity in the BMD density along the diameter of the wafer. The above-mentioned first maximum target temperature exceeding 1400° C. is a high temperature and therefore is likely to cause slip dislocation etc., that is not preferred.

In order to allow a longer lifetime of the thermal treatment apparatus to be used, it is preferable that an upper limit for the above-mentioned first maximum target temperature is 1380° C. or less.

It is preferable that the cooling rate at which the wafer is cooled from the above-mentioned first maximum target temperature in the above-mentioned first heat treatment is from 50 to 250° C./second.

As described above, since the above-mentioned first heat treatment is performed in the oxidizing gas atmosphere, a lot of interstitial silicon is generated. At the same time, vacancy with a thermal balance concentration is also generated. This vacancy and interstitial oxygen form an O2-V complex. Originating from this O2-V complex, the BMD core is generated in the second heat treatment to be carried out later.

In addition, in the case where the above-mentioned cooling rate is less than 50° C./second, the above-mentioned vacancy diffuses outwards and disappears when cooling, so that the O2-V complex may not be formed.

Therefore, by setting the cooling rate in the first heat treatment as 50° C./second and or more, many vacancies occurred as described above may be caused to remain in the bulk. For this reason, it is possible to sufficiently achieve generating and growing the BMD core (increasing the BMD density) in the above-mentioned second heat treatment.

In addition, in the case where the above-mentioned cooling rate is too large, the slip dislocation may take place in the wafer because of the rapid cooling, and it is preferable that its upper limit is 250° C./second or less.

More preferably, the cooling rate in the above-mentioned first heat treatment is from 120 to 250° C./second.

By choosing such a cooling rate, it is possible to improve the in-plane uniformity in the BMD density along the diameter of the bulk of the wafer and its size.

It is preferable that the cooling from the above-mentioned first maximum target temperature at the above-mentioned cooling rate is performed to between 400° C. and 600° C. from the viewpoints, such as controlling the diffusion of the above-mentioned interstitial silicon, productivity, etc.

Further, in the case where the OSF ring exists along the diameter of (or concentrically with) the wafer, or even in the case where there is a BMD low density region within the wafer, the method for heat-treating the silicon wafer in accordance with the present invention can improve the in-plane uniformity in BMD density and its size.

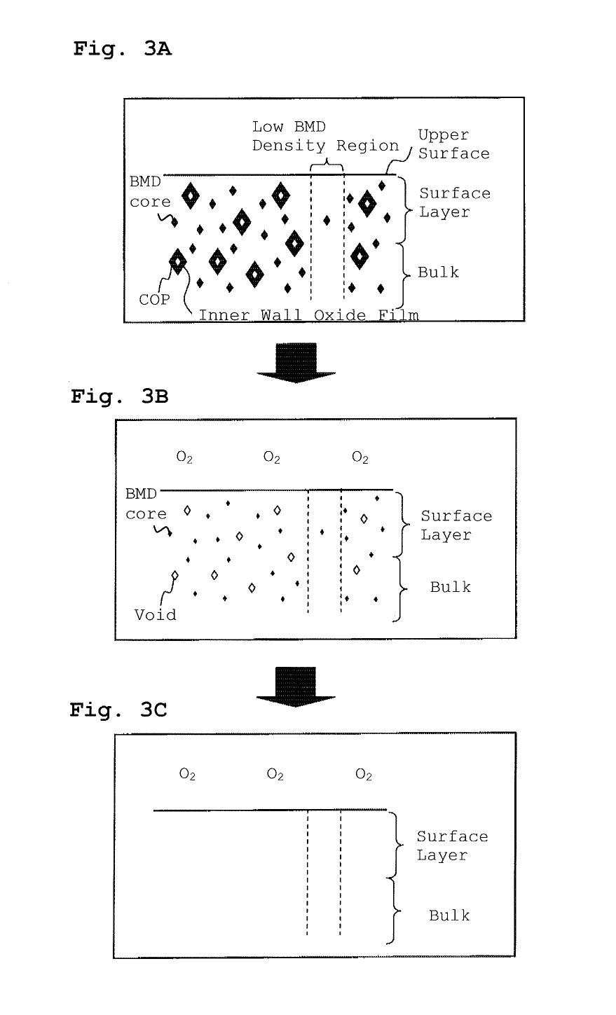

FIGS. 3A to 3C are schematic flow diagrams in a wafer cross-section for explaining the effects of the present invention in the first heat treatment in the case where the OSF ring exists along the diameter of the wafer (or concentrically with the wafer).

In the wafer where the OSF ring exists, as described above, there is the BMD low density region in which the BMD density falls greatly near the OSF ring (FIG. 3A).

According to the method for heat-treating the silicon wafer in accordance with the pre sent invention, by performing the above-mentioned first heat treatment, COP and the BMD core disappear even in such a wafer, as with the mechanism similar to that described with reference to FIGS. 1A to 1C (FIGS. 3B-3C).

Therefore, the variation in the BMD core in the BMD low density region can be eliminated, so that the in-plane uniformity in BMD density and its size can be improved, even if there is the OSF ring along the diameter of (or concentrically with) the wafer.

Further, in the method for heat-treating the silicon wafer in accordance with the present invention, in the case where an oxygen concentration in the wafer to be heat-treated is high (i.e., in the case where the oxygen concentration is controlled to be high at the time of growing the single crystal), COP may remain in the surface layer of the wafer after the first heat treatment.

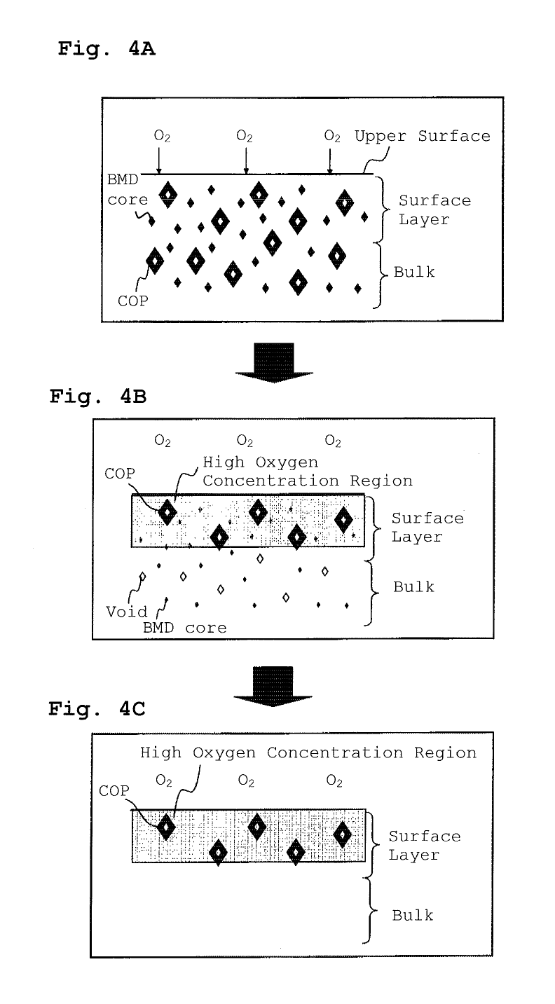

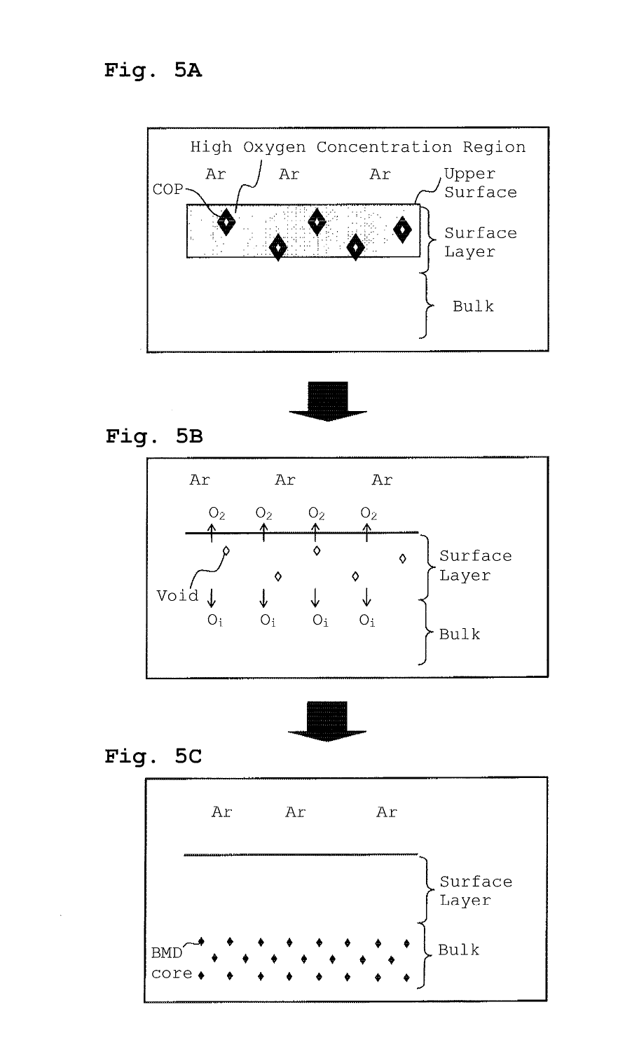

FIGS. 4A to 4C and 5A to 5C are schematic flow diagrams in the wafer cross-section for explaining the effects of the present invention in the case where the oxygen concentration in the wafer to be heat-treated is high. FIGS. 4A to 4C show the effect of the first heat treatment, and FIGS. 5A to 5C show the effect of the second heat treatment.

Since oxygen contained in the oxidizing gas atmosphere is diffused inwards in the surface layer from the wafer surface in the first heat treatment, the oxygen concentration in the surface layer is close to a solid solubility limit in the case where the oxygen concentration in the wafer to be heat-treated is high (FIGS. 4A-4B). Therefore, it is hard to dissolve the inner wall oxide film of COP in the surface layer. Thus, since a lot of introduced interstitial silicon cannot be buried in COP, there is COP remaining in the surface layer. It should be noted that since the BMD core is small even in the case of a high oxygen concentration, the BMD core introduced at the time of growing the single crystal dissolves and disappears within the wafer (FIGS. 4A-4C).

However, as shown in FIG. 4C, even if COP remains in the surface layer in the first heat treatment, the heat treatment is carried out at the temperature range of from 900 to 1250° C. in the non-oxidizing gas atmosphere (argon in FIG. 5) in the second heat treatment. This heat treatment causes oxygen to diffuse outwards from the surface layer and causes the bulk to diffuse outwards, so that the oxygen concentration of the above-mentioned surface layer falls from near the solid solubility limit (FIG. 5B).

Thus, since performing the above-mentioned second heat treatment causes the oxygen concentration to fall in the surface layer, the inner wall oxide film of COP existing in the surface layer dissolves and results in a void. Then, the void disappears as silicon atoms are re-arranged (FIGS. 5B-5C). Further, as in FIGS. 2A to 2C, a BMD core does not precipitate in the surface layer of the wafer but precipitates in the bulk (FIG. 5C).

As described above, according to the method for heat-treating the silicon wafer in accordance with the present invention, in the case where the oxygen concentration in the wafer to be heat-treated is high, it is possible to improve the in-plane uniformity in the BMD density of the bulk and its size. In addition, COP at the surface layer of the wafer can be reduced.

In the present invention, by “the case where the oxygen concentration is high” we mean the oxygen concentration in the wafer is greater than 1.2×10¹⁸ atoms/cm³ (old-ASTM).

If the above-mentioned first heat treatment is performed not in the oxidizing gas atmosphere but in the non-oxidizing gas atmosphere (reducing gas atmosphere (hydrogen gas, nitrogen gas, etc.) and an inert gas atmosphere (argon gas etc.)), the BMD core of the bulk introduced at the time of growing the single crystal cannot be eliminated, but the BMD core will be grown up conversely. This is because outward diffusion of oxygen is greatly promoted from the above-mentioned surface layer to the bulk.

It is preferable that a partial pressure of the oxygen gas in the above-mentioned oxidizing gas atmosphere is from 20 to 100% (preferably 100% oxygen gas).

By setting the above-mentioned partial pressure of oxygen gas as 20% or more, a lot of interstitial silicon can be introduced into the wafer and COP can be reliably reduced, that is preferred.

In addition, it is preferable that a gas other than oxygen gas in the above-mentioned oxidizing gas atmosphere is argon gas (except for the case where the partial pressure of oxygen gas is 100%).

By using argon gas, it is possible to avoid formation of other films, such as a nitride film, chemical reactions, etc., more reliably.

It is preferable that the maximum target temperature (second maximum target temperature) in the above-mentioned second heat treatment is within the range of from 900 to 1250° C.

In the case where the above-mentioned second maximum target temperature is less than 900° C., that is a low temperature, then the outward diffusion of oxygen is hard to take place, as described above. For this reason, the inner wall oxide film of COP remaining in the surface layer of the wafer is hard to dissolve and it is difficult to eliminate COP in the surface layer.

In the case where the above-mentioned second maximum target temperature exceeds 1250° C., the outward diffusion of oxygen from the surface layer of the wafer becomes large. Thus, the oxygen concentration in the surface layer falls greatly and pinning effect of oxygen against the slip dislocation is reduced, so that the slip dislocation may occur in the wafer.

In the case of performing the above-mentioned second heat treatment not in the non-oxidizing gas atmosphere but in the above-mentioned oxidizing gas atmosphere, oxygen is inwardly diffused in the surface layer of the wafer. Therefore, in the case of the silicon wafer with a high oxygen concentration, the oxygen concentration in the surface layer is kept high. Thus, the inner wall oxide film of COP remaining in the surface layer of the wafer in the second heat treatment is hard to dissolve, and it may be difficult to eliminate COP in the surface layer.

It is preferable that the above-mentioned non-oxidizing gas atmosphere is a non-oxidizing gas (preferably 100% argon gas) containing argon gas.

By using argon gas, it is possible to perform the heat treatment without causing formation of other films, such as a nitride film, chemical reactions, etc.

It is preferable that using a known rapid thermal processing (RTP: Rapid Thermal Process, hereinafter simply referred to as RTP) apparatus, the above-mentioned first heat treatment is carried out by RTP. It should be noted that by RTP herein we mean rapid thermal processing at a heating or cooling rate of 1° C./second or more.

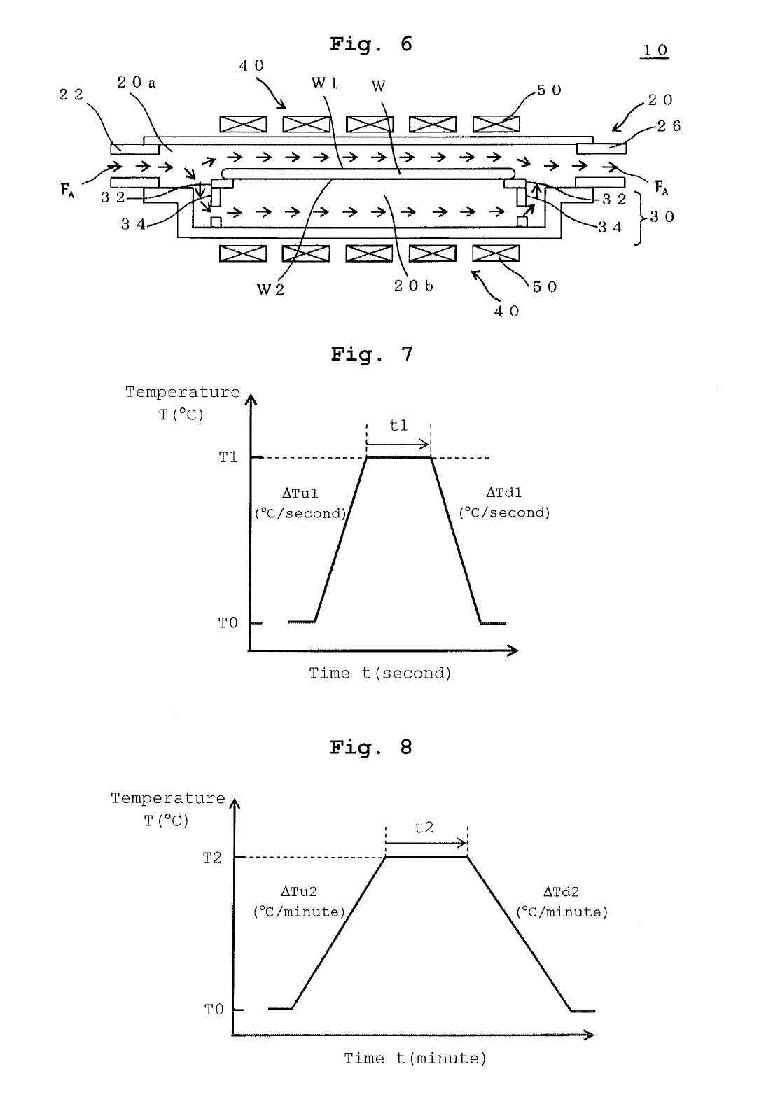

FIG. 6 is a schematic cross-sectional view showing an example of the RTP apparatus used for the method for heat-treating the silicon wafer in accordance with the present invention.

The RTP apparatus 10 shown in FIG. 6 is provided with a reaction chamber 20 for accommodating and heat-treating a wafer W, a wafer holding part 30 arranged in the reaction chamber 20 to hold the wafer W, and a heating part 40 for heating the wafer W. In a situation where the wafer W is held at the wafer holding part 30, a first space 20a and a second space 20b are formed. The first space 20a is a space surrounded by an inner wall of the reaction chamber 20 and an upper surface (device formation side) W1 side of the wafer W. The second space 20b is a space surrounded by an inner wall of the reaction chamber 20 and the back W2 side of the wafer W in which the back W2 is opposed to the surface W1 side.

The reaction chamber 20 is provided with an inlet 22 and an outlet 26. The above-mentioned inlet 22 is for supplying an atmosphere gas F_{A} (shown by solid arrows) into the first space 20a and the second space 20b. Further, the above-mentioned outlet 26 is for discharging the thus supplied atmosphere gas F_{A} from the first space 20a and the second space 20b. The reaction chamber 20 is formed of quartz, for example.

The wafer holding part 30 is provided with a susceptor 32 which holds the periphery section of the back W2 of the wafer W in the shape of a ring, and a rotator 34 which holds the susceptor 32 and rotates the susceptor 32 about the center of the wafer W. The susceptor 32 and the rotator 34 are formed of SiC, for example.

A heating part 40 is constituted by a plurality of halogen lamps 50. The above-mentioned plurality of halogen lamps 50 are arranged outside the reaction chamber 20 above the upper surface W1 and below the back W2 of the wafer W held at the wafer holding part 30, so that the wafer W is heated from both sides by lamp heating which is optical irradiation of the above-mentioned halogen lamps 50.

Heat treatment using the RTP apparatus 10 shown in FIG. 6 is performed as follows:

The wafer W is introduced into the reaction chamber 20 through a wafer feed port (not shown) provided for the reaction chamber 20, and the periphery section of the back W2 of the wafer W is held in the shape of a ring on the susceptor 32 of the wafer holding part 30. The wafer W is heated by the heating part 40, while supplying the atmosphere gas F_{A} through the above-mentioned inlet 22 and rotating the wafer W.

FIG. 7 is a graph showing an example of a temperature sequence of the first heat treatment by RTP.

As shown in FIG. 7, the silicon wafer is held on the rotatable susceptor arranged in a reaction space of the known RTP apparatus which is held at a temperature T0 (preferably from 400 to 600° C. inclusive), and an oxidizing gas is supplied into the above-mentioned reaction space. Next, the temperature is rapidly increased from the temperature T0 to between 1325° C. and 1400° C. (inclusive: temperature T1) which is the first maximum target temperature at a heating rate of ΔTu1 (° C./second). The temperature is kept constant (temperature T1) for a predetermined period of time (t1 (second)). Then, it is rapidly decreased at a cooling rate of ΔTd1 (° C./second) from the temperature T1 to the temperature T0, for example.

In the case where the wafer W is placed in the reaction chamber 20 of RTP apparatus 10 as shown in FIG. 6, the above-mentioned temperatures T0 and T1 are measured by radiation thermometers (not shown) arranged below the wafer holding part 30, and are surface temperatures (mean temperature; when plural radiation thermometers are arranged in the radial directions of the wafer W) of the wafer W.

It is preferable that retention time t1 during which the above-mentioned first maximum target temperature is maintained is from 1 to 60 seconds.

In the case where the above-mentioned retention time t1 is less than 1 second, it may be difficult to fully eliminate the BMD core and COP introduced at the time of growing the single crystal. In the case where the above-mentioned retention time t1 exceeds 60 seconds, productivity may fall and the other faults (impurity diffusion, slip, etc.) caused by heat treatment may take place.

It is preferable that the above-mentioned second heat treatment is carried out by way of the heat treatment using a vertical thermal treatment apparatus. A known apparatus (for example, vertical thermal treatment apparatus shown in Japanese Patent Application Publication (KOKAI) No. 2001-85349 etc.) is used as the above-mentioned vertical thermal treatment apparatus. It should be noted that by “heat treatment using a vertical thermal treatment apparatus” herein we mean slow heat treatment at a heating/cooling rate of 15° C./minute or less.

FIG. 8 is a graph showing an example of a temperature sequence of the second heat treatment using the vertical thermal treatment apparatus.

As shown in FIG. 8, a known vertical boat holding a plurality of silicon wafers is installed in the reaction space of the known vertical thermal treatment apparatus held at the temperature T0 (preferably from 400 to 600° C. inclusive), and non-oxidizing gas (for example, argon gas) is supplied into the above-mentioned reaction space. Next, the temperature is raised from the temperature T0 to between 900° C. and 1200° C. (inclusive: temperature T2) which is the second maximum target temperature at a heating rate of ΔTu2 (° C./minute). The temperature is kept constant (temperature T2) for a predetermined period of time (t2 (minute)). Then, it is cooled at a cooling rate of ΔTd2 (° C./minute) from the temperature T2 to the temperature T0, for example.

It is preferable that the retention time t2 for maintaining the above-mentioned second maximum target temperature is from 1 to 120 minutes.

In the case where the above-mentioned retention time t2 is less than 1 minute, it may be difficult to sufficiently precipitate and grow the BMD core in the bulk of the wafer. Further, in the case where the oxygen concentration of the silicon wafer is high, COP in the surface layer may not fully be eliminated in the second heat treatment. In the case where the above-mentioned retention time t2 exceeds 120 minutes, the productivity may fall and the faults (impurity diffusion, slip, etc.) caused by heat treatment may take place.

It is preferable that the heating rate (ΔTu2 in FIG. 8) at which the temperature is raised to the above-mentioned second maximum target temperature in the above-mentioned second heat treatment is from 1 to 20° C./minute and the cooling rate (ΔTd2 in FIG. 8) at which the temperature is decreased from the above-mentioned second maximum target temperature is from 1 to 5° C./minute.

Further, it is more preferable that the heating rate (ΔTu2 in FIG. 8) at which the temperature is raised to the above-mentioned second maximum target temperature in the above-mentioned second heat treatment is from 1 to 5° C./minute and the cooling rate (ΔTd2 in FIG. 8) at which the temperature is decreased from the above-mentioned second maximum target temperature is from 1 to 5° C./minute.

By choosing such a heating rate and a cooling rate, it is possible to control the generation of the slip dislocation at the time of heating in the above-mentioned second heat treatment. Further, it is possible to improve the BMD density.

It is preferable that the heating rate (ΔTu1 in FIG. 7) at the time of heating in the above-mentioned first heat treatment is from 10 to 250° C./second in order to improve the productivity and reduce the generation of the slip more.

As for growing the silicon single crystal ingot by the CZ process, it is preferable to grow the silicon single crystal ingot including a V-rich region where a lot of vacancies (COP) are taken in by controlling a V/G ratio (V: pull rate, G: average of temperature gradients in a crystal in the direction of a raising axis in a temperature range from melting point of silicon to 1300° C.).

In particular, using a known single crystal growing apparatus, a seed crystal is brought into contact with a surface of a silicon melt, the seed crystal is pulled up while rotating the seed crystal and a quartz crucible, and a neck portion and a larger diameter portion which is enlarged to have a desired diameter are formed. Then, while maintaining the desired diameter, a straight cylindrical portion is formed by controlling the V/G ratio to be a predetermined value (for example, 0.25 to 0.35 mm²/° C.·min) so that it may have a V-rich region. Then, a reduced diameter portion whose diameter is smaller than the desired diameter is formed, and the ingot is separated from the silicon melt.

By carrying out such a process, it is possible to improve the productivity at the time of growing the single crystal.

It should be noted that “including a V-rich region” herein does not exclude the above-mentioned OSF region.

Next, a method for manufacturing a silicon wafer using the above-described method for heat-treating the silicon wafer will be described.

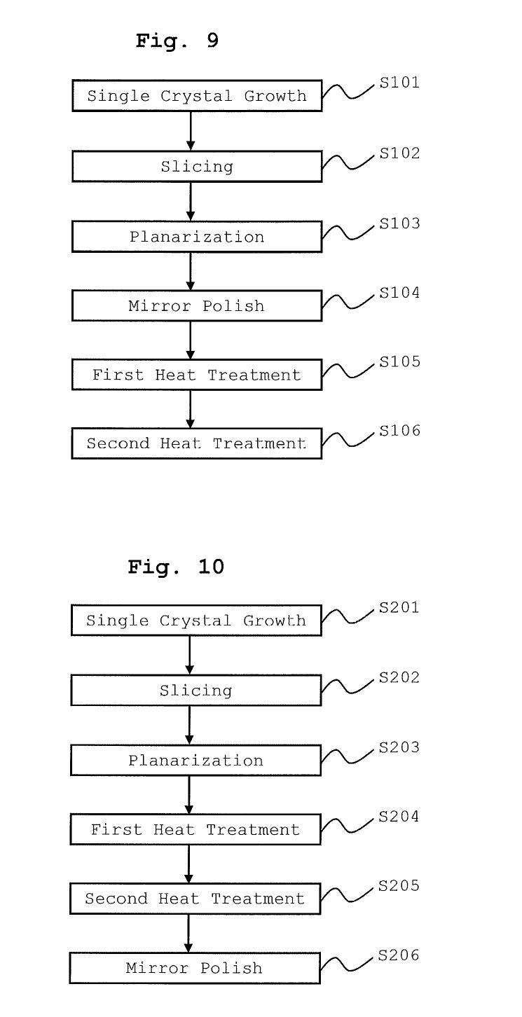

FIG. 9 is a flow chart showing a first embodiment of the method for manufacturing the silicon wafer including the method for heat-treating the silicon wafer in accordance with the present invention.

The above-mentioned first embodiment includes a step of growing a silicon single crystal ingot by the CZ process (S101), a step of slicing the above-mentioned silicon single crystal ingot to produce a disk-shaped wafer (S102), a step of planarizing the front and back of the sliced wafer as produced above (S103), a step of mirror polishing at least a surface of the above-mentioned planarized wafer, the surface being a semiconductor device formation side (S104), and a step of subjecting the above-mentioned mirror polished wafer to the above-mentioned first heat treatment (S105) and second heat treatment (S106).

In other words, in the above-mentioned first embodiment, the wafer whose surface is at least mirror polished and serves as the semiconductor device formation side is subjected to the above-described method for heat-treating the silicon wafer.

The provision of such steps allows obtaining the silicon wafer which provides the above-mentioned effects more reliably.

It should be noted that the above-mentioned planarization includes a known lapping process, a one side grinding process, a two side grinding process, and an etching process (the etching process is for example an acid etching process where the whole surface of the above-mentioned planarized wafer is immersed in an acid etching solution in which hydrofluoric acid (HF), nitric acid (HNO₃), acetic acid (CH₃COOH), and water (H₂O) are mainly mixed at a certain ratio).

The above-mentioned mirror polish includes known one side polish and two side polish.

In other words, in the above-mentioned planarization (S103) to the above-mentioned mirror polish (S104), the two side grinding process is carried out after the front and back of the sliced wafer as produced above are lapped, for example. It includes a step of polishing two sides later, a step of performing the etching process after lapping, then polishing two sides, etc.

FIG. 10 is a flow chart showing a second embodiment of the method for manufacturing the silicon wafer including the method for heat-treating the silicon wafer in accordance with the present invention.

The above-mentioned second embodiment includes a step of growing a silicon single crystal ingot by the CZ process (S201), a step of slicing the above-mentioned silicon single crystal ingot to produce a disk-shaped wafer (S202), a step of planarizing the front and back of the sliced wafer as produced above (S203), a step of subjecting the above-mentioned planarized wafer to the above-mentioned first heat treatment (S204) and the second heat treatment (S205), and a step of mirror polishing at least a surface of the wafer subjected to the above-mentioned second heat treatment, the surface being a semiconductor device formation side (S206).

In other words, in the above-mentioned second embodiment, the above-mentioned method for heat-treating the silicon wafer is applied to the planarized wafer.

In addition to the above-mentioned effects, the provision of such steps allows, for example the outward diffusion of oxygen from the surface layer to be reduced at the time of the second heat treatment, and if COP remains in the surface layer, the surface layer can be removed at the later polishing step, that is preferred.

The planarized wafer to be heat-treated in the above-mentioned second embodiment includes a wafer subjected to the lapping process, a wafer subjected to the etching process.

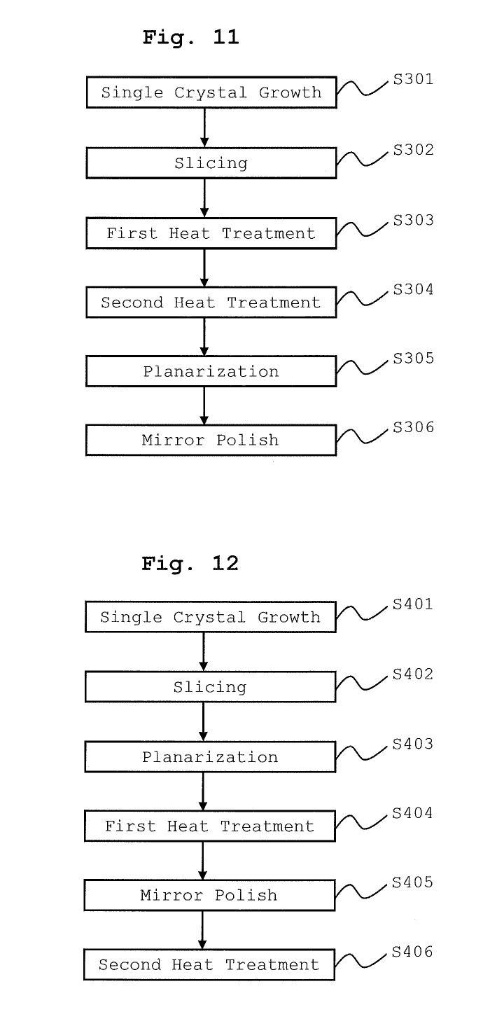

FIG. 11 is a flow chart showing a third embodiment of the method for manufacturing the silicon wafer including the method for heat-treating the silicon wafer in accordance with the present invention.

The above-mentioned third embodiment includes a step of growing a silicon single crystal ingot by the CZ process (S301), a step of slicing the above-mentioned silicon single crystal ingot to produce a disk-shaped wafer (S302), a step of subjecting the sliced wafer as produced above to the above-mentioned first heat treatment (S303) and second heat treatment (S304), a step of planarizing the front and back of the sliced wafer subjected to the above-mentioned second heat treatment (S305), and a step of mirror polishing at least a surface of the above-mentioned planarized wafer, the surface being a semiconductor device formation side (S306).

In other words, in the above-mentioned third embodiment, the above-mentioned method for heat-treating the silicon wafer is applied to the sliced wafer.

The provision of such steps allows obtaining the effects similar to those in the above-mentioned second embodiment.

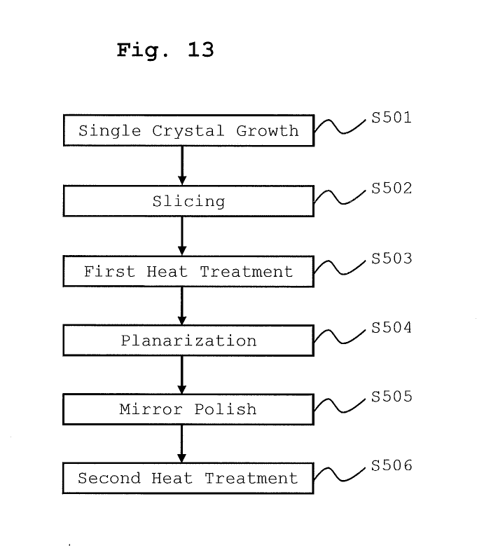

FIG. 12 is a flow chart showing a fourth embodiment of the method for manufacturing the silicon wafer including the method for heat-treating the silicon wafer in accordance with the present invention.

The above-mentioned fourth embodiment includes a step of growing a silicon single crystal ingot by the CZ process (S401), a step of slicing the above-mentioned silicon single crystal ingot to produce a disk-shaped wafer (S402), a step of planarizing the front and back of the sliced wafer as produced above (S403), a step of subjecting the above-mentioned planarized wafer to the above-mentioned first heat treatment (S404), a step of mirror polishing at least a surface of the wafer subjected to the above-mentioned first heat treatment, the surface being a semiconductor device formation side (S405), and a step of subjecting the above-mentioned mirror polished wafer to the above-mentioned second heat treatment (S406).

In other words, according to the above-mentioned fourth embodiment, the first heat treatment is carried out after planarization and the second heat treatment is carried out after mirror polishing in the above-described method for heat-treating the silicon wafer.

In addition to the above-mentioned effects, since such steps are provided, if COP remains in the surface layer after the first heat treatment, it can be removed at the later polishing step. Thus, it is possible to reduce the processing burden in the second heat treatment (reduction in heat treatment temperature, heat treatment time, etc.)

FIG. 13 is a flow chart showing a fifth embodiment of the method for manufacturing the silicon wafer including the method for heat-treating the silicon wafer in accordance with the present invention.

The above-mentioned fifth embodiment includes a step of growing a silicon single crystal ingot by the CZ process (S501), a step of slicing the above-mentioned silicon single crystal ingot to produce a disk-shaped wafer (S502), a step of subjecting the sliced wafer as produced above to the above-mentioned first heat treatment (S503), a step of planarizing the front and back of the wafer subjected to the above-mentioned first heat treatment (S504), a step of mirror polishing at least a surface of the above-mentioned planarized wafer, the surface being a semiconductor device formation side (S505), and a step of subjecting the above-mentioned mirror polished wafer to the above-mentioned second heat treatment (S506).

In other words, according the above-mentioned fifth embodiment, the first heat treatment is applied to the sliced wafer and the second heat treatment after mirror polishing in the above-mentioned method for heat-treating the silicon wafer.

The provision of such steps allows obtaining the effects similar to those in the above-mentioned fourth embodiment.

### EXAMPLES

Hereinafter, the present invention will be described more particularly with reference to Examples; however, the following Examples should not be construed as limiting the present invention.

### (Experiment 1)

By way of the CZ process, a silicon single crystal ingot was grown by controlling a V/G ratio (V: pull rate, G: average of temperature gradients in a crystal in the direction of a raising axis in a temperature range from melting point of silicon to 1300° C.). A lot of vacancies (COP) were taken in the ingot to have a V-rich region and an OSF ring was generated, when sliced, at a part within a plane of the wafer. The silicon wafer (with a diameter of 300 mm, a thickness of 775 μm, and an oxygen concentration of 1.2×10¹⁸ to 1.3×10¹⁸ atoms/cm³) which was sliced from the above-mentioned region and in which both its sides were mirror polished was placed in a reaction space, which was held at 400° C., of a known RTP apparatus. Then, with a temperature sequence as shown in FIG. 7, a first heat treatment was performed in a gas (flow rate: 20 slm) atmosphere of 100% oxygen such that the wafer was heated at a heating rate of 50° C./second for a retention time of 15 seconds (however, 30 seconds in Comparative Example 1) at the maximum target temperature by varying the maximum target temperature and cooling rate, thus producing a plurality of wafers by varying heat treatment conditions.

Subsequently, the wafer subjected to the above-mentioned first heat treatment was placed in a reaction space, which was held at 600° C., of a known vertical thermal treatment apparatus. Then, with a temperature sequence as shown in FIG. 8, a second heat treatment was carried out in a gas (flow rate: 30 slm) atmosphere of 100% argon such that the wafer was heated at a heating rate of 1 to 20° C./minute to a maximum target temperature of 1200° C. for a retention time of 1 hour, and cooled to 600° C. at a cooling rate of 1 to 5° C./minute.

Further, as Conventional Example, a wafer was produced which was not subjected to the above-mentioned first heat treatment but subjected only to the above-mentioned second heat treatment.

Next, the wafer subjected to the above-mentioned second heat treatment was subjected to a BMD precipitating heat treatment (at 800° C. for 4 hours and at 1000° C. for 16 hours) in a gas atmosphere of 100% oxygen. The wafer subjected to the above-mentioned BMD precipitating heat treatment was measured by an IR topography (MO-441, manufactured by Raytex Corporation, Japan). The BMD density and dispersion light intensity were evaluated along the diameter direction in the bulk (a depth of 7 μm to 300 μm) which was at a depth of 7 μm or more from the wafer surface and was from the center of the wafer to its periphery. Further, based on the dispersion light intensity as evaluated above, using Equation (1), BMD sizes were calculated at three points which were a position in the center of the wafer (0 mm), a position (within a BMD low density region) diametrically 110 mm away from the center of the wafer, and a position (wafer periphery) 145 mm away from the center.

BMD size=dispersion light intensity(1/6)×20 Equation (1)

Further, using an LSTD scanner MO601 manufactured by Raytex Corporation, the number of defects at the surface layer in a region of from the surface of the wafer subjected to the above-mentioned second heat treatment to a depth of 5 μm was evaluated to calculate the defect density.

Furthermore, by means of an X-ray topography (XRT300, manufactured by Rigaku Corporation, Japan), a length of a slip was evaluated which was generated at the back of the wafer subjected to the above-mentioned second heat treatment.

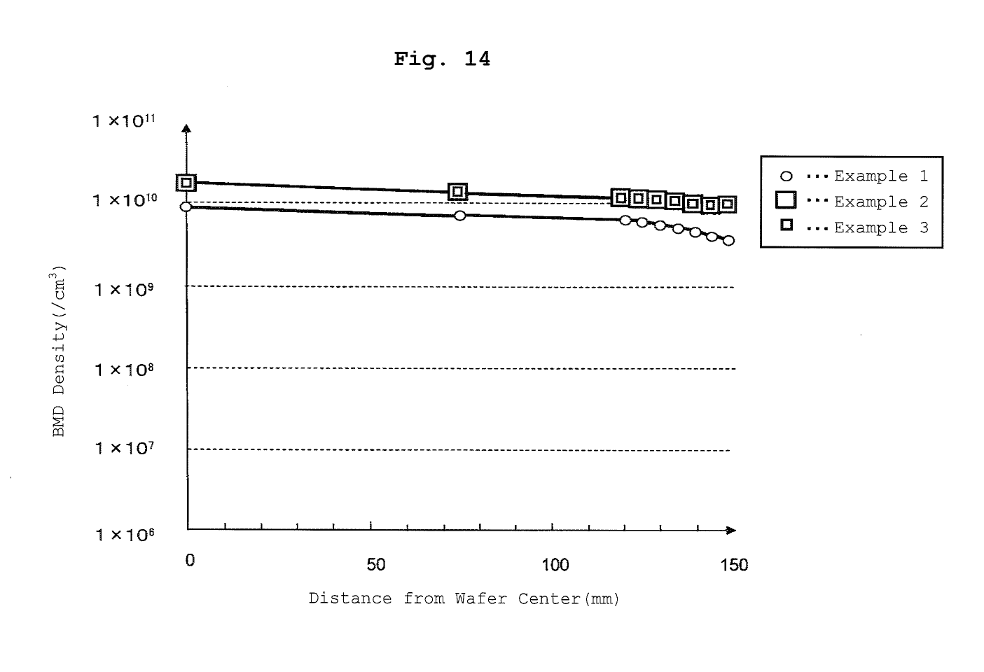

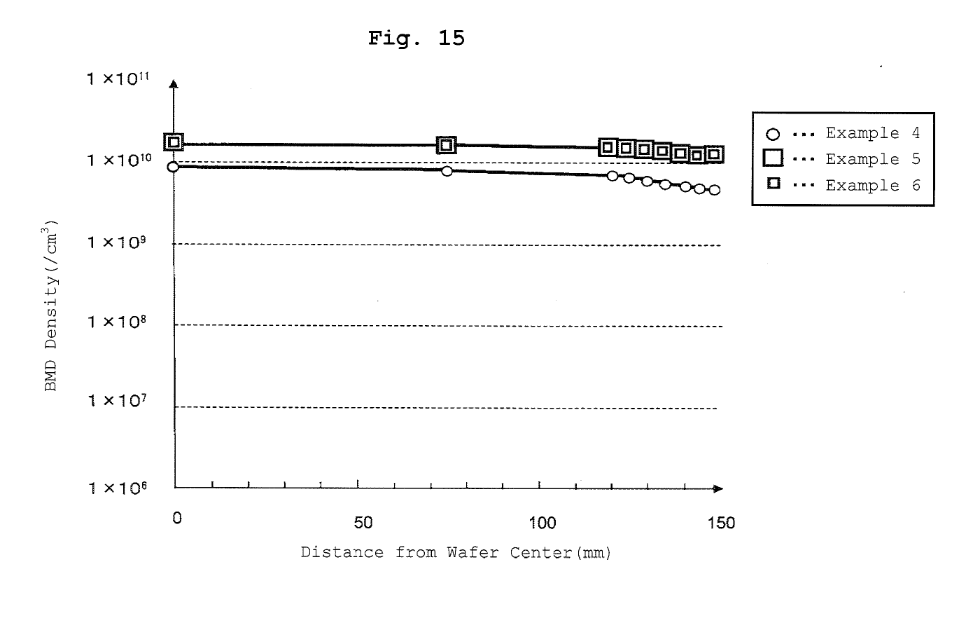

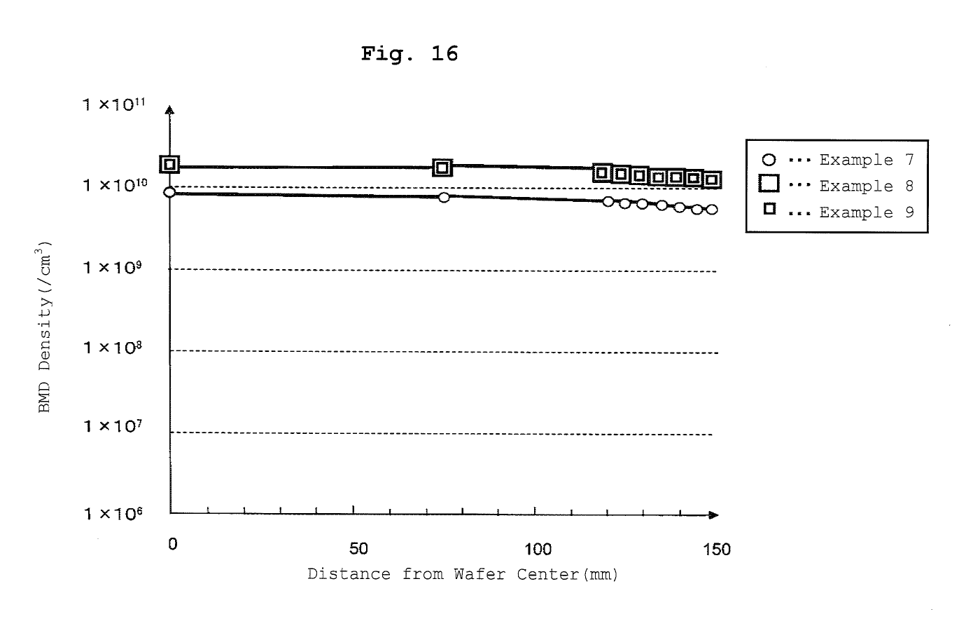

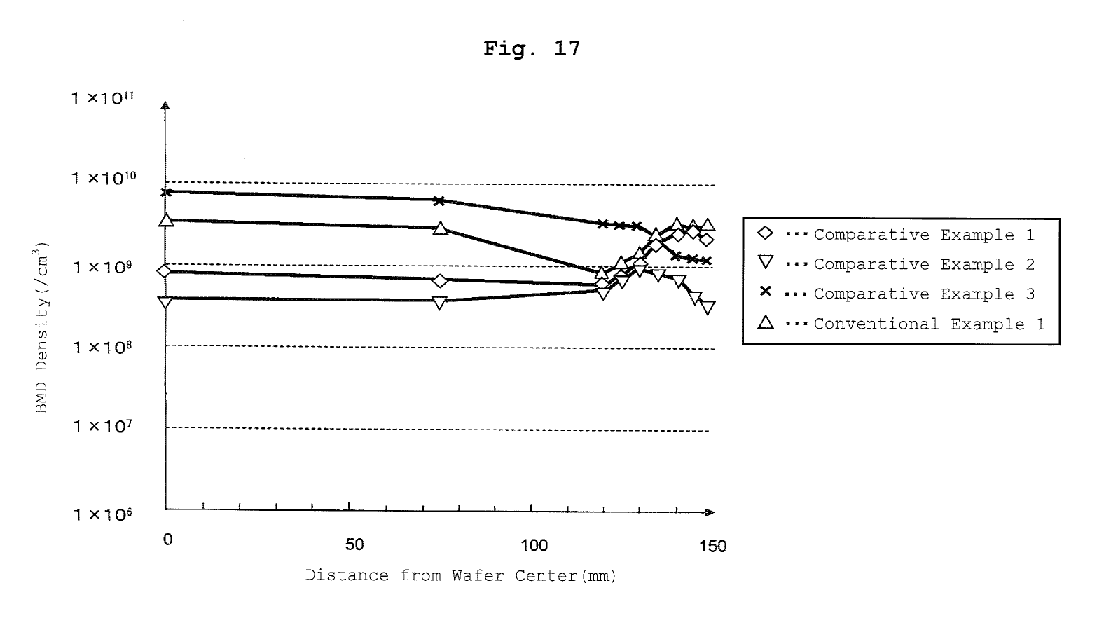

Table 1 shows experiment conditions and evaluation results (surface layer defect density and BMD average size). FIGS. 14 to 17 each show in-plane distributions of the BMD densities along the wafer diameter from the center of the wafer to the periphery under the respective conditions in the present experiment.

TABLE 1

| | First Heat Treatment | | Surface | | | | |
|---|---|---|---|---|---|---|---|
| | Maximum | | Layer | BMD Average Size (nm) | | | |
| | Target | Cooling | Defective | Wafer | Position | Position | |
| | Temperature | Rate (° C./ | Density | Central | at | at | Maximum |
| | (° C.) | second) | (/cm²) | Point | 110 mm | 140 mm | Difference |
| Comparative | 1250 | 25 | 0.11 | 66 | 73 | 85 | 19 |
| Example 1 | | | | | | | |
| Comparative | 1300 | 25 | 0.11 | 66 | 72 | 80 | 14 |
| Example 2 | | | | | | | |
| Comparative | 1350 | 25 | 0.10 | 67 | 70 | 75 | 8 |
| Example 3 | | | | | | | |
| Example 1 | 1325 | 50 | 0.12 | 66 | 69 | 71 | 5 |
| Example 2 | 1325 | 120 | 0.11 | 67 | 68 | 69 | 2 |
| Example 3 | 1325 | 250 | 0.13 | 66 | 68 | 68 | 2 |
| Example 4 | 1350 | 50 | 0.13 | 67 | 68 | 70 | 3 |
| Example 5 | 1350 | 120 | 0.11 | 67 | 67 | 67 | 0 |
| Example 6 | 1350 | 250 | 0.12 | 66 | 66 | 66 | 0 |
| Example 7 | 1380 | 50 | 0.11 | 67 | 68 | 69 | 2 |
| Example 8 | 1380 | 120 | 0.11 | 67 | 67 | 67 | 0 |
| Example 9 | 1380 | 250 | 0.10 | 67 | 67 | 67 | 0 |
| Conventional | — | — | 0.13 | 66 | 74 | 90 | 24 |
| Example 1 | | | | | | | |

As can be seen from Table 1 and FIGS. 14 to 17, it is confirmed that performing the first heat treatment before the second heat treatment allows better in-plane uniformity in the BMD size along the diameter of the wafer than performing only the second heat treatment (Conventional Example 1).

Further, when the maximum target temperature of the first heat treatment is 1300° C. or less (Comparative Examples 1 and 2), even if it is 1350° C., it is confirmed that a cooling rate of 25° C./second (Comparative Example 3) does not allow sufficient in-plane uniformities in the BMD density and the size along the diameter of the wafer.

On the other hand, when it is 1325° C. or more and cooling rates are 50° C./second or more (Examples 1 to 9), it is confirmed that the in-plane uniformities in the BMD density and the size along the diameter of the wafer are improved. Furthermore, when the cooling rate is 120° C./second or more (Examples 2, 3, 5, 6, 8, or 9), it is confirmed that both the BMD density and the size are almost flat.

Further, it is confirmed that the defect density of the surface layer is low under any condition.

It should be noted that a slip dislocation on the back of wafer side is not identified under any condition.

### (Experiment 2)

The maximum target temperatures in the above-mentioned first heat treatment were set as 1325° C., 1350° C., and 1380° C., and the cooling rate was set as 50° C./second. Further, by varying the second maximum target temperature, the second heat treatment was performed under the same conditions as those in Examination 1 except for the varied temperatures.

Next, similar to Experiment 1, as for the wafer subjected to the above-mentioned second heat treatment, the number of defects at the surface layer in a region of from the surface of the wafer subjected to the above-mentioned second heat treatment to a depth of 5 μm was evaluated using the LSTD scanner MO601 manufactured by Raytex Corporation to calculate the defect density.

Furthermore, by means of the X-ray topography (XRT300, manufactured by Rigaku Corporation), a length of a slip was evaluated which was generated at the back of the wafer subjected to the above-mentioned second heat treatment.

Table 2 shows experiment conditions and evaluation results (surface layer defect density) in Experiment 1.

TABLE 2

| | Maximum | Maximum | |
|---|---|---|---|
| | Target | Target | |
| | Temperature | Temperature of | Surface |
| | of First | Second Heat | Layer Defect |
| | Heat Treatment | Treatment | Density |
| | (° C.) | (° C.) | (/cm²) |
| Comparative Example 4 | 1325 | 800 | 2.56 |
| Example 10 | 1325 | 900 | 0.63 |
| Example 11 | 1325 | 1100 | 0.34 |
| Example 12 | 1325 | 1250 | 0.11 |
| Comparative Example 5 | 1325 | 1300 | 0.11 |
| Comparative Example 6 | 1350 | 800 | 3.16 |
| Example 13 | 1350 | 900 | 0.71 |
| Example 14 | 1350 | 1100 | 0.45 |
| Example 15 | 1350 | 1250 | 0.11 |
| Comparative Example 7 | 1350 | 1300 | 0.11 |
| Comparative Example 8 | 1380 | 800 | 3.56 |
| Example 16 | 1380 | 900 | 0.84 |
| Example 17 | 1380 | 1100 | 0.51 |
| Example 18 | 1380 | 1250 | 0.11 |
| Comparative Example 9 | 1380 | 1300 | 0.11 |

It should be noted that in Comparative Examples 5, 7, and 9, although slip dislocation with a length of 5 to 10 mm was identified in the back of the wafer, other observations were not identified.

As can be seen from the above results, when the maximum target temperature is set as 800° C. (Comparative Examples 4, 6, and 8) in the second heat treatment, it is confirmed that the defect density of the surface layer is high. Further, when the maximum target temperature is set as 1300° C. (Comparative Examples 5, 7, and 9), it is confirmed that a slip is generated.

On the other hand, when the maximum target temperature is set as 900 to 1250° C. in the second heat treatment, it is confirmed that the defect density of the surface layer is also less than 1.0/cm².

What is claimed is;:

1. A method for heat-treating a silicon wafer, comprising the steps of:
performing a first heat treatment in which the silicon wafer sliced from a silicon single crystal ingot grown by Czochralski process is heated to a first maximum target temperature within a range of from 1325 to 1400° C. in an oxidizing gas atmosphere, held at said first maximum target temperature, and then cooled at a cooling rate of from 50 to 250° C./second; and
performing a second heat treatment in which said silicon wafer subjected to the first heat treatment is heated to a second maximum target temperature within a range of from 900 to 1250° C. in a non-oxidizing gas atmosphere, held at said second maximum target temperature, and then cooled.

2. A method for heat-treating a silicon wafer as claimed in claim 1, wherein the cooling rate in said first heat treatment is 120 to 250° C./second.

3. A method for heat-treating a silicon wafer as claimed in claim 1, wherein the heating rate at which the silicon wafer is heated to said second maximum target temperature in said second heat treatment is 1 to 20° C./minute.

4. A method for heat-treating a silicon wafer as claimed in claim 2, wherein the heating rate at which the silicon wafer is heated to said second maximum target temperature in said second heat treatment is 1 to 20° C./minute.
